(19) United States
(12) Patent Application Publication
(10) Pub. No.: US 2012/0327121 A1
(43) Pub. Date: Dec. 27, 2012

(54) METHODS FOR TOUCH SCREEN CONTROL OF PAPERLESS RECORDERS

(75) Inventors: Sachin Dhawade, Pune (IN); Abhijit Jadhav, Pune (IN); Haresh Chouksey, Pune (IN)

(73) Assignee: Honeywell International Inc., Morristown, NJ (US)

(21) Appl. No.: 13/166,012

(22) Filed: Jun. 22, 2011

(51) Int. Cl. G06F 3/041; G09G 5/00

(52) U.S. Cl. 345/649; 345/173; 345/660

(57) ABSTRACT

A method and system for manipulating the display of a paperless recorder. The method comprises providing a touchscreen associated with a paperless recorder. The display of the paperless recorder can be manipulated using a plurality of finger movements. The display of the paperless recorder and the associated data provided on the touchscreen is then displayed according to the finger movement. Thereby allowing a user to control paperless recorders in a fashion that is intuitively similar to paper-based recorders, which utilizes natural human gestures to accomplish desired actions.

### TECHNICAL FIELD

Embodiments are generally related to the field of computer applications. Embodiments are also related to the field of process industry data recorders. Embodiments are additionally related to methods and systems for controlling paperless touchscreen data recorders.

### BACKGROUND OF THE INVENTION

Data recorders are commonly used in the process manufacturing industry. Recording events, trends, or variables can be an important part of process control. Historically, data recorders were paper based. Operators could scroll through historic recorder data by moving the paper in the data recorder from left to right or vice versa. However, as computers have become more common, the process industry has increasingly utilized paperless data recorders to provide data and information to operators. Current paperless data recorder interfaces use soft buttons for screen navigation and to perform specific actions. However, based on historical paper data recorders these controls are not intuitive.

Existing methods and systems do not adequately account for the historic operator familiarity with paper-based data recorders. Specifically, existing methods do not allow operators to control paperless data recorders in a fashion that is intuitively similar to paper-based data recorders. Therefore, a need exists for a paperless data recorder, which utilizes natural human gestures to accomplish desired actions.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide for a method and system for data recording.

It is another aspect of the disclosed embodiments to provide for an enhanced method and system for interfacing with a data recorder.

It is another aspect of the disclosed embodiments to provide an enhanced method and system for manipulating and displaying data on a process industry data recorder.

It is yet another aspect of the disclosed embodiments to provide a method and system for controlling paperless touchscreen data recorders.

The aforementioned aspects and other objectives and advantages can now be achieved as described herein. A method for interfacing with a paperless recorder. The method comprises providing a touchscreen. The paperless recorder can provide a strip chart or a circular chart.

The display of the paperless recorder can be manipulated using a variety of finger movements. These movements include motions to manipulate menus and buttons, pan, zoom, and rotate the display, and derive trace values, among others.

The display of the paperless recorder and the associated data on the paperless recorder is then displayed according to the finger movement. Thereby allowing a user to control paperless recorders in a fashion that is intuitively similar to paper-based recorders, which utilizes natural human gestures to accomplish desired actions.

Thus, in some embodiments, an interface method can be implemented, which includes the steps of displaying data on a touchscreen of a paperless recorder, manipulating the display of the paperless recorder using a plurality of finger movements, and redisplaying the paperless recorder data on the touchscreen of the paperless recorder according to the plurality of finger movements. In another embodiment, the paperless recorder can provide a strip chart. In still another embodiment, the paperless recorder can provide a circular chart.

In other embodiments, the step of manipulating the display of the paperless recorder, can further comprise a step of two finger tapping the touchscreen and sweeping the fingers across the touchscreen wherein the two finger tapping and sweeping displays current or historic data on the paperless recorder. In another embodiment, the step of manipulating the display of the paperless recorder, can further comprise the step of spreading two fingers away from each other to provide a zoom-in display and bring two fingers together to provide a zoom-out display on the paperless recorder.

In yet another embodiment, the step of manipulating the display of the paperless recorder, can further comprise the step of rotating two fingers on the touchscreen display to provide a rotated display on the touchscreen. In still other embodiments, the step of manipulating the display of the paperless recorder, can further comprise the step of tapping a pre programmed hot button to navigate to the predetermined location associated with the hot button. In other embodiments, the step of manipulating the display of the paperless recorder, can further comprise the step of tapping and then sweeping a finger down the touchscreen to provide a pull down display on the display of the paperless recorder. In another embodiment, the step of manipulating the display of the paperless recorder can further comprise a step of manipulating the display of the paperless recorder provides a preview display on the paperless recorder.

In another embodiment, a paperless recorder interface method can be implemented, which includes, for example, the steps of displaying data on a touchscreen of a paperless recorder, manipulating the display of the paperless recorder using a plurality of finger movements, and redisplaying the paperless recorder data on the touchscreen of the paperless recorder according to the plurality of finger movements.

In another embodiment, the step of manipulating the display of the paperless recorder using a plurality of finger movements, can further comprise the steps of two finger tapping the touchscreen and sweeping the fingers across the touchscreen wherein the two finger tapping and sweeping displays current or historic data on the touchscreen recorder, spreading two fingers apart on the touchscreen in order to zoom-in, bringing two fingers together on the touchscreen in order to zoom-in, rotating two fingers on the touchscreen in order to rotate the display, and tapping and sweeping a finger down the touchscreen to provide a pull down display.

In still another embodiment, a system for software interface with a paperless recorder, can be implemented that includes, for example, a processor, and a data bus coupled to the processor. Additionally, such a system can include a computer-usable medium embodying computer code, the computer-usable medium being coupled to the data bus. In some embodiments, the computer program code can includes instructions executable by the processor and configured for displaying data on a touchscreen of the paperless recorder, manipulating the display of the paperless recorder using a plurality of finger movements, and redisplaying the paperless recorder data on the touchscreen of the paperless recorder according to the plurality of finger movements. In some embodiments, the paperless recorder can provide a strip chart and/or a circular chart.

In other embodiments, the aforementioned instructions can be configured for two finger tapping the touchscreen and sweeping the fingers across the touchscreen wherein the two finger tapping and sweeping displays current or historic data on the paperless recorder, spreading two fingers away from each other to provide a zoom-in display and bring two fingers together to provide a zoom-out display on the paperless recorder, rotating two fingers on the touchscreen display to provide a rotated display on the touchscreen, tapping a pre programmed hot button to navigate to the predetermined location associated with the hot button, tapping and then sweeping a finger down the touchscreen to provide a pull down display on the display of the paperless recorder, and/or manipulating the display of the paperless recorder provides a preview display on the paperless recorder.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a front view of a paperless recording device in which aspects of the present invention may be implemented;

FIGS. 3a-3b depicts an exploded front view of paperless recorder hot buttons which are implemented in accordance with the disclosed embodiments;

FIG. 4a depicts an exploded front view of a paperless recorder chart area and associated scrolling action which is implemented in accordance with the disclosed embodiments;

FIG. 4b depicts an exploded front view of a paperless recorder chart area and associated zooming action which is implemented in accordance with the disclosed embodiments;

FIG. 4c depicts an exploded front view of a paperless recorder chart area and associated panning action which is implemented in accordance with the disclosed embodiments;

FIG. 5 depicts a front view of a paperless recorder chart area and associated rotating action which is implemented in accordance with the disclosed embodiments;

FIG. 6 depicts an exploded front view of a paperless recorder cursor navigation area and associated cursor navigation action which is implemented in accordance with the disclosed embodiments;

FIG. 7 depicts an exploded front view of a paperless recorder screen navigation area and associated navigation action which is implemented in accordance with the disclosed embodiments;

FIG. 8 depicts an exploded front view of a paperless recorder context sensitive menu and associated tap action which is implemented in accordance with the disclosed embodiments;

FIG. 9 depicts an exploded front view of a paperless recorder screen preview area and associated tap action which is implemented in accordance with the disclosed embodiments;

FIG. 10 depicts an exploded front view of an alternative embodiment of a paperless recorder with a circular chart area and associated scrolling action which is implemented in accordance with the disclosed embodiments;

FIG. 11a depicts an exploded front view of an alternative embodiment of a paperless recorder with a circular chart area and associated value axis zooming action which is implemented in accordance with the disclosed embodiments;

FIG. 11b depicts an exploded front view of an alternative embodiment of a paperless recorder with a circular chart area and associated time axis zooming action which is implemented in accordance with the disclosed embodiments;

FIG. 12 depicts a high-level flow chart of operations depicting logical operational steps of a method for navigating a paperless recorder in accordance with a preferred embodiment of the present invention.

### DETAILED DESCRIPTION

The particular values and configurations discussed in these non-limiting examples can be varied and are cited merely to illustrate at least one embodiment and are not intended to limit the scope thereof.

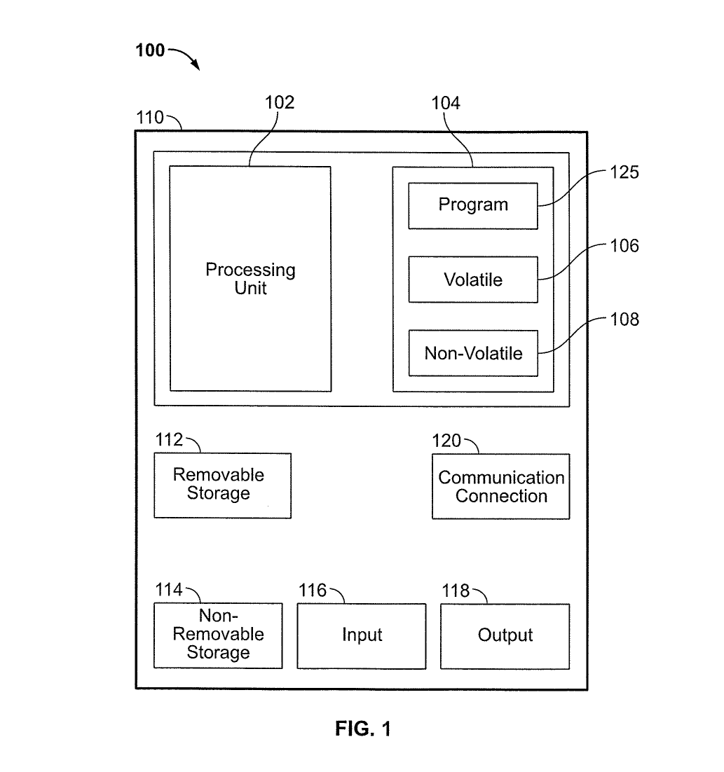

A block diagram of a computer system 100 that executes programming for executing the methods and systems disclosed herein is shown in FIG. 1. A general computing device in the form of a computer 110, may include a processing unit 102, memory 104, removable storage 112, and non-removable storage 114. Memory 104 may include volatile memory 106 and non-volatile memory 108. Computer 110 may include or have access to a computing environment that includes—a variety of computer-readable media, such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions, as well as data, including video frames. Note that although not shown in FIG. 1, it can be appreciated that a data bus can be included, which may connect various electrical components.

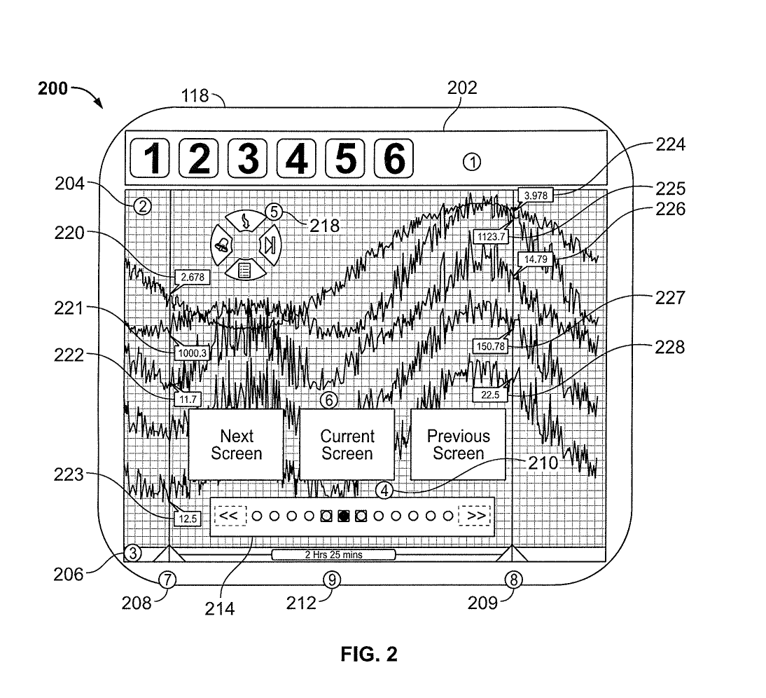

Computer 110 may include or have access to a computing environment that includes input 116, output 118, and a communication connection 120. For example input 116, output 118, and communication connection 120 may be embodied as a process recorder like those embodied in FIG. 2. The computer may operate in a networked environment using a communication connection to connect to one or more remote computers. The remote computer may include a personal computer (PC), server, router, network PC, a peer device or other common network node, or the like. FIG. 1 may be implemented as a standalone paperless recorder such as a Honeywell Paperless Recorder. The communication connection may include a Local Area Network (LAN), a Wide Area Network (WAN) or other networks.

Output 118 may be provided as a computer monitor but can include any output device. Output 118 allows a user to navigate through the virtual environment embodied by computer system 100. In addition, Output 118 and input 116 may be commonly embodied in a touchscreen, which allows a user to select and instruct computer system 100. The user interface can further be provided as a touchscreen of a process recorder using output 118 and input 116.

Computer-readable instructions, for example program module 125, are stored on a computer-readable medium and are executable by the processing unit 102 of computer 110. Program module 125 may include an application. A hard drive, CD-ROM, RAM, Flash Memory, and a USB drive are just some examples of articles including a computer-readable medium.

FIG. 2 depicts a paperless recording device 200 in which aspects of the present invention may be implemented. Paperless recording device 200 provides data via chart area 204 and screen preview area 210. Additionally data recording device 200 includes hot buttons 202. A cursor navigation area 206 and a screen navigation area 214 provide navigational tools for manipulating data recording device 200. Data recording device 200 also includes a context sensitive menu 218.

Data recording device 200 can include two cursors; cursor 1, 208 and cursor 2, 209. Cursors can provide exact recorder values at the respective cursor location for each trace as indicated by trace values 220-228. Cursor 1, 208 and Cursor 2, 209 can be separated by time interval 212. A user can also adjust time interval 212 as necessary.

Paperless recording device 200 is intended to provide easy navigational operation via touchscreen 118 and a gesture based user interface that allows an operator to intuitively navigate to an intended virtual location. For typical operations such as zooming, chart scrolling, navigation to other screens, and altering screen orientation, the finger gestures to achieve those operations are based on natural human gestures. While paperless recording device 200 represents one type of paperless recording device used in the process industry, one skilled in the art will appreciate that the disclosed systems and methods could also be provided on other known data recording implementations such as strip charts, circular charts, and the like.

The following description is presented with respect to embodiments of the present invention, which can be embodied in the context of a data-processing system such as computer system 100, in conjunction with program 125, and paperless recording device 200 depicted in FIGS. 1 and 2. The present invention, however, is not limited to any particular application or any particular environment. Instead, those skilled in the art will find that the system and methods of the present invention may be advantageously applied to a variety of systems and associated application software. Moreover, the present invention may be embodied on a variety of different platforms, including Macintosh, UNIX, LINUX, and the like. Therefore, the descriptions of the exemplary embodiments, which follow, are for purposes of illustration and not considered a limitation.

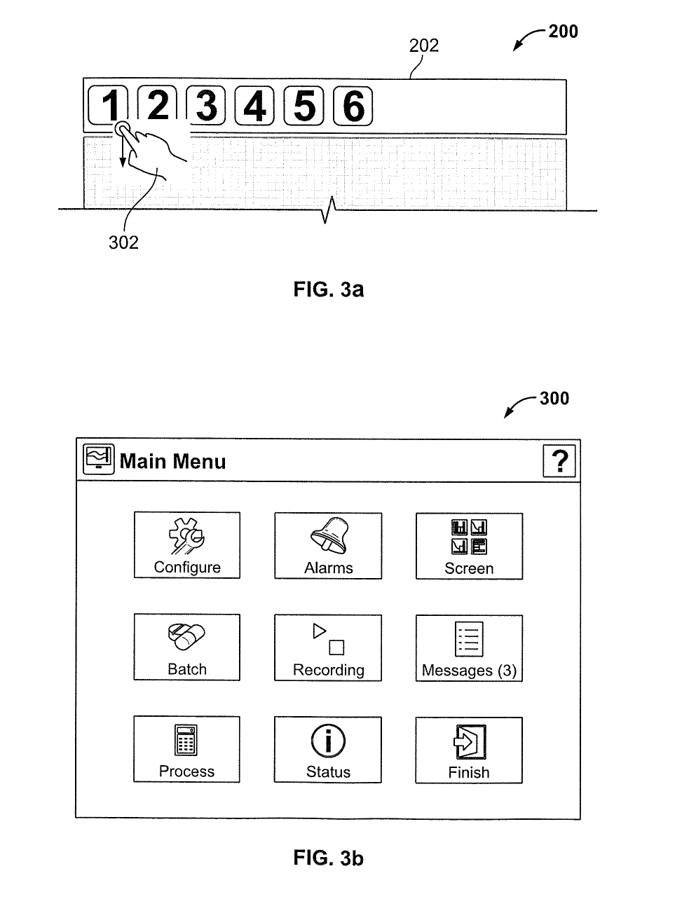

FIG. 3a illustrates an exploded view of the upper edge of the paperless recording device 200. This area is populated with several hot buttons 202 (illustrated as buttons 1-6). Each of the hot buttons 202 provide navigational connections to information or menus related to the current paperless recording device 200 display. Hot buttons are activated by finger tapping or touching the desired hot button and then swiping the finger away from the hot button 202.

For example, in FIG. 3a, hand 302 is shown tapping hot button 1 of hot buttons 202. By tapping a hot button the action associated with that button can be executed. A swiping down action can lead to the display of Main Menu 300, illustrated in FIG. 3b. One skilled in the art will appreciate that FIG. 3a and FIG. 3b are only intended to illustrate one example of the type of navigational connection to information or menu that may be associated with a given hot button. Any number of other navigational connections to information or menus can be provided via hot buttons 202 when activated by being finger tapped followed by a swiping finger motion.

In a preferred embodiment hot buttons 202 are provided as a strip of hot buttons located at the top of the paperless recording device display 118. The hot buttons 202 remain constantly visible to provide easy access to the associated navigational connections or menus.

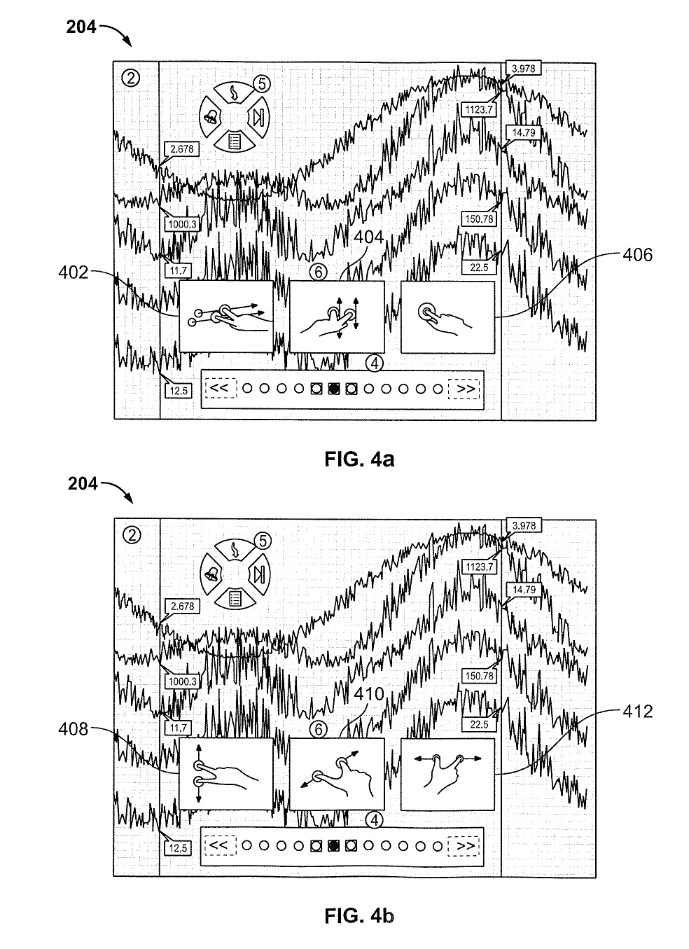

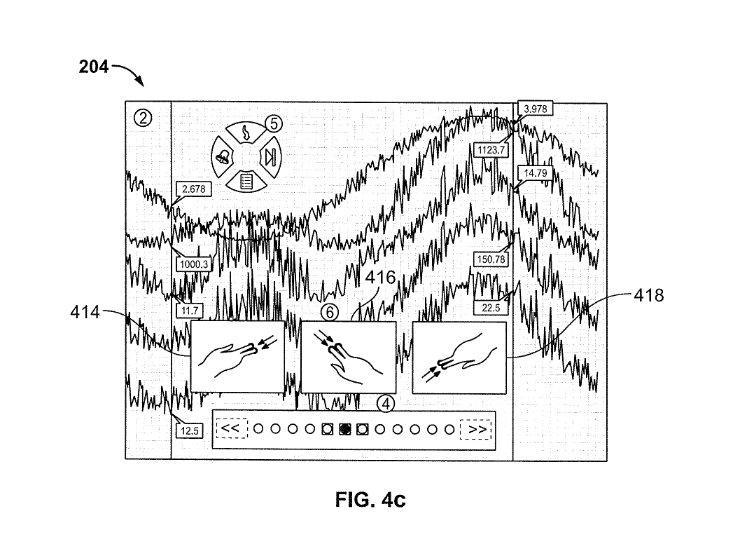

FIGS. 4a-4c illustrate an exploded view of chart area 204. Chart area 204 generally occupies the maximum space on display 118. A variety of natural gestures can be used to manipulate the view of chart area 204. FIG. 4a illustrates a scrolling gesture that can be used to navigate the chart area 204. Scrolling is accomplished using a two finger scroll gesture, where two fingers are simultaneously moved parallel to one another in the direction scrolling is desired. The scrolling gesture allows a user to view current or historic data in chart area 204.

The chart area 204 may be scrolled along the x-axis bi directionally. This is shown in FIG. 4a. Hand 402 is illustrated moving two fingers in parallel across chart area 204 from left to right. This gesture would result in the chart area 204 being equivalently scrolled. Likewise, a right to left gesture (not shown) would result in an opposite direction scroll.

Chart area 204 may also be scrolled along the y-axis bi directionally, as indicated in FIG. 4a. Hand 404 is shown moving two fingers in parallel across chart area 204 from the bottom upwards. This gesture would result in chart area 204 being equivalently scrolled up. A similar gesture from the top downward (not shown) would result in the opposite direction scroll.

Scrolling speed is controlled by the speed of the initiating gesture. Any scrolling motion of chart area 204 can be stopped by single finger tapping anywhere in the chart area 204. This gesture is illustrated by hand 406 which is shown single finger tapping chart area 204.

Chart area 204 can also be expanded or contracted using a zooming gesture as illustrated by FIG. 4b. Chart area 204 can be zoomed on the x-axis, y-axis, or a combination of directions simultaneously. Zooming out is preformed by simultaneously placing two fingers on touchscreen 118 and moving them away from each other. Zooming in is accomplished by placing two fingers on touchscreen 118 and moving them towards each other (not shown). When chart area 204 is in either a state of expansion or contraction, it can be returned to its original size by finger touch tapping anywhere inside the chart area 204.

Hand 408 illustrates a zoom-in gesture along the y-axis. As the fingers of hand 408 are spread apart in the y aligned direction, the chart area will be expanded along the y-axis. Similarly, Hand 412 illustrates a zoom-in gesture along the x-axis, where the fingers are spread apart in the x aligned direction. Hand 410 illustrates a zoom-in operation in a direction comprising a combination of x and y directions. As the fingers of hand 410 are moved apart the chart area 204 will be expanded along the axis formed by the direction the fingers are moved. This allows for expansion and contraction of the chart area 204 along any direction necessary.

FIG. 4c illustrates a Panning gesture. When the chart area 204 is magnified, or zoomed-in as shown in FIG. 4B, the traces can be viewed by panning the chart area 204. Hands 414, 416, and 418 illustrates a panning hand gesture. The panning gesture is accomplished by moving two fingers together along chart area 204. A panning gesture can be made in any direction.

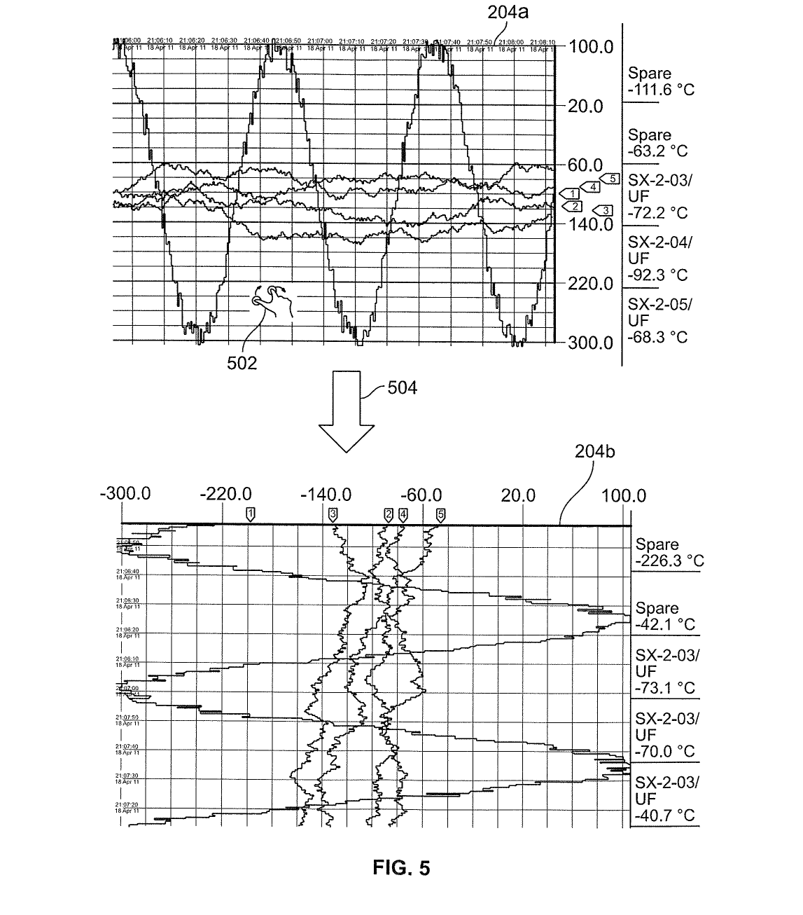

The orientation of chart area 204 can also be changed using a rotation hand gesture as illustrated in FIG. 5. The rotation hand gesture allows for the repositioning of the chart area 204. In FIG. 5, chart area 204a represent the initial position of the chart area. Hand 502 is acting on chart area 204a. The rotation hand gesture requires placing two fingers on the chart area, and rotating them in the same direction at an equal speed. After the rotation hand gesture occurs indicated by arrow 504, the chart area 204b is rotated 90 degrees.

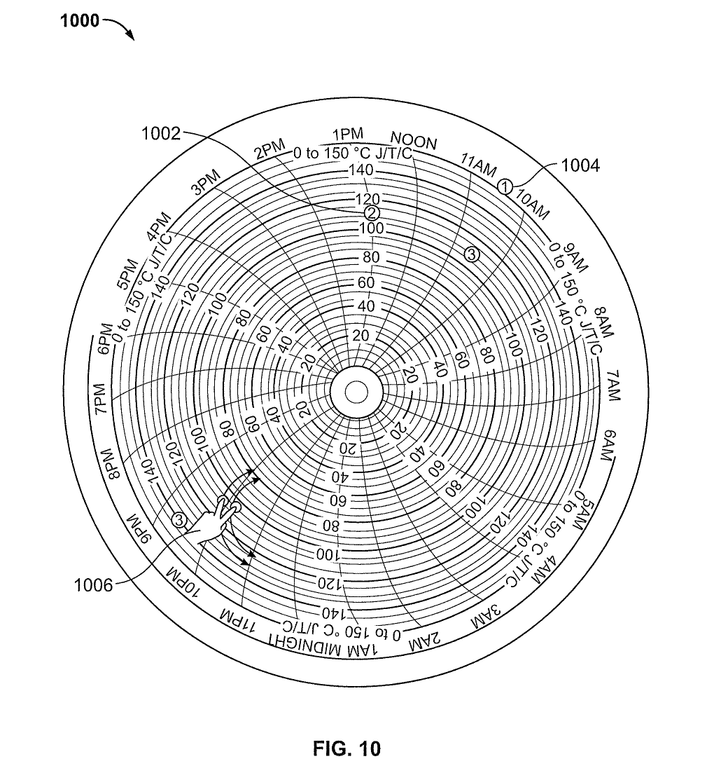

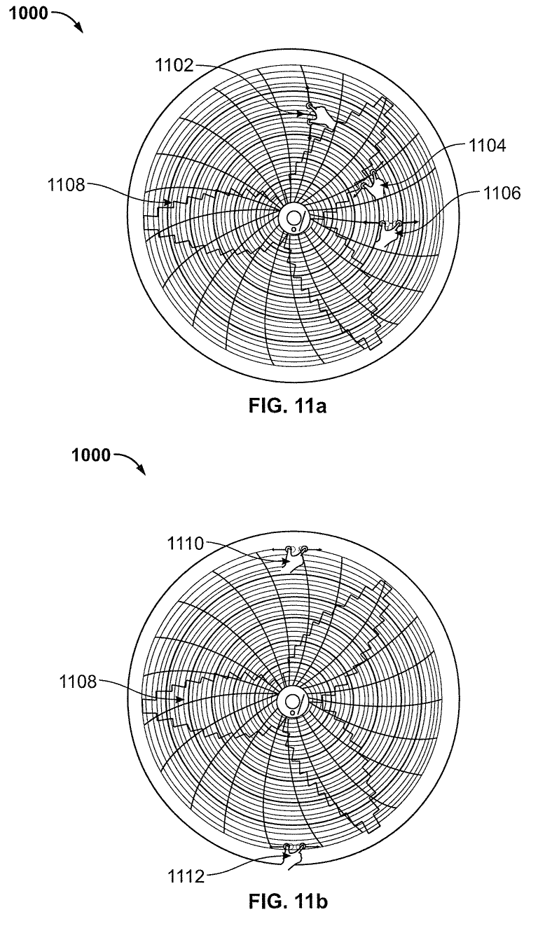

It is important to note that although chart area 204 illustrates a rotation gesture as applied to a strip chart such a gesture may also be applied to other chart types such as a circular chart as discussed below and shown in FIGS. 10 and 11. In FIG. 5, the chart area 204 is rotated exactly 90 degrees. However, the rotation can be limited according to the users preference by simply rotating the fingers more or less. Likewise, twisting the fingers in either direction, clockwise or counter clockwise can initiate the rotation. These features may be particularly useful in the context of a circular chart (shown in FIG. 10).

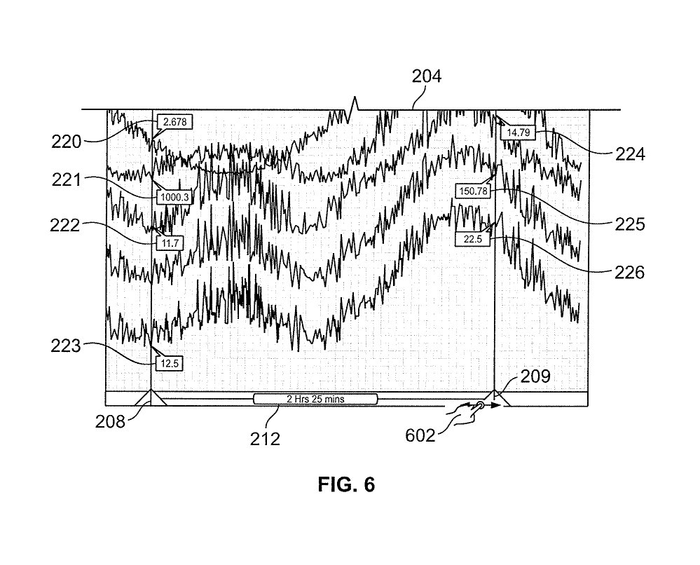

FIG. 6 shows the cursor navigation function of chart area 204, and associated hand gesture 602. The bottom most portion of chart area 204 provides a set of cursors 208 and 209. A skilled artisan will appreciate any number of cursors may be used, and FIG. 6 includes two cursors for exemplary purposes only.

Cursors 208 and 209 can be adjusted by placing a finger on the cursor 208 or 209 until the cursor is selected and then dragging the finger along the bottom of the chart area, as shown by hand gesture 602. Each of cursors 208 and 209 can be moved independently along the x-axis. As a cursor 208 or 209 is adjusted, the trace value of any of the traces will be displayed as balloon windows illustrated by trace values 220-223, associated with cursor 208 and trace values 224-226, associated with cursor 209.

Additionally, the time between two cursors, for example cursors 208 and 209, will be provided in between the two cursors by time interval 212. Time interval 212 will be adjusted to reflect the time between cursor 208 and 209. Alternatively, time interval 212 can be set either by positioning the cursors 208 and 209, or by selecting the time interval 212 and entering a time value. The time interval bar 212 can then be selected and adjusted which will cause both cursors 208 and 209 to adjust simultaneously. The time interval bar 212 is manipulated by placing a finger on the time interval bar 212 until it is selected and then dragging the finger horizontally along chart area 204 (this action not shown).

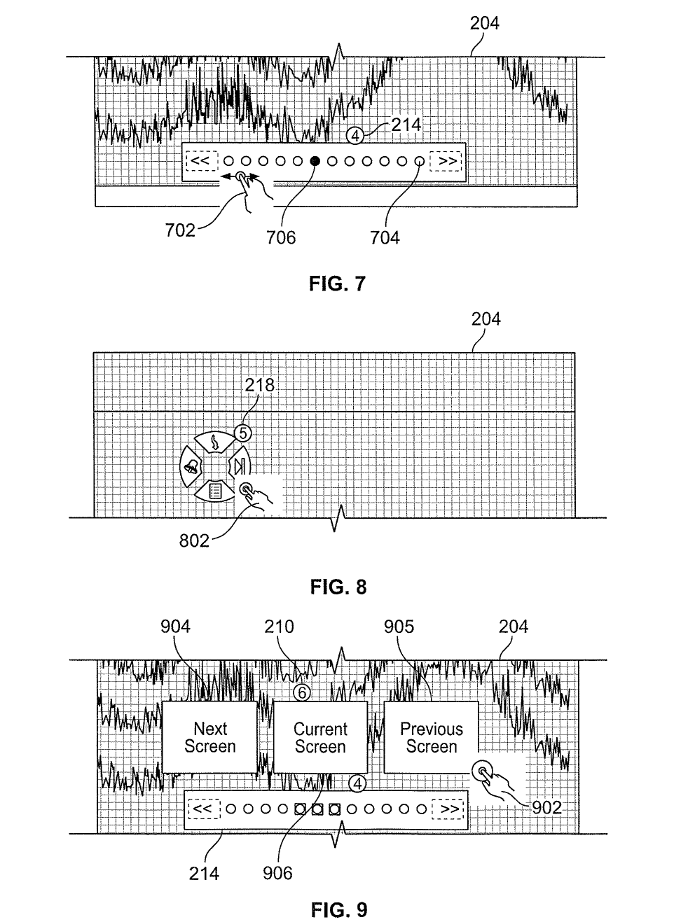

Paperless recorder 200 may include a screen preview area 210 associated with chart area 204, as shown in FIG. 9. The screen preview area 210 provides a small preview of the screen selected as a user slides his finger through the screen navigation area 214 as illustrated in FIG. 7. The screen preview area 210 includes the current screen 906, previous screen 905, and next screen 904. To open the full display of one of the preview screens 905-906, a user double taps the preview as shown by hand 902.

FIG. 7 illustrates a screen navigation area 214 associated with chart area 204. Screen navigation area 214 is a rectangular box provided at the bottom of chart area 204, with a series of circles, for example 704, which are mapped to a specific screen associated with the paperless recorder 200. The screen navigation area 214 will not be permanently visible to a user. A user can activate the screen navigation area 214 by implementing a single finger flicking gesture (not shown). Upon detection of this gesture, screen navigation area 214 will be displayed. A user can then quickly navigate between screens by selecting a circle in screen navigation area 214 such as 704. After a preset period of inactivity, the screen navigation area 214 will disappear from chart area 204 to provide maximum view space in chart area 204.

Hand 702 indicates that a user can navigate between screens by placing a finger on a circle such as 704 or 706 in screen navigation area 214 and then sliding the finger from circle to circle in screen navigation area 214. When the user's finger contacts a given circle a preview of that screen is displayed in chart area 204. The screen preview area is shown in FIG. 9. The circle 706 associated with the screen currently open is highlighted to provide the user a quick navigational reference.

A context sensitive menu 218 associated with chart area 204 is shown in FIG. 8. The context sensitive menu 218 provides specific actions associated with the open page. Therefore, as the open page changes the options provided in the context menu will also change to the specific options provided for that page.

To open the context sensitive menu 218, the user has to tap the screen with one finger and hold it for a specified amount of time. Preferably this time is between 1 and 3 seconds. This action is indicated by hand 802 in FIG. 8. Thereafter, context sensitive menu 218 is displayed. The context sensitive menu 218 can be invoked using the aforementioned gesture at any location in chart area 204.

Some examples of options that might be provided in the context sensitive menu 218 are an option to start playing the chart, which displays trace values in real time, an option to move the live chart to the end and start playing the chart from that position, an option to display log messages, or an option to display any current alarms. A skilled artisan will appreciate that any number of other options may be provided depending on design considerations. In a preferred embodiment the context sensitive menu 218 would include an icon associated with each action option.

FIG. 10 depicts an exploded front view of an alternative embodiment of a paperless recorder with a circular chart area 1000. The circular chart area 1000 consists of concentric circles. The outermost circle represents the time axis 1004, which may also be considered the x-axis. The inner concentric circles represent the value axis 1002. In general, any of the actions or buttons described with respect to a strip chart may also be implemented with the circular chart area 1000 and vice versa.

For example, circular chart area 1000 can be scrolled in either a clockwise or counterclockwise direction using a two finger scrolling gesture as illustrated by hand 1006. As with the strip chart, the speed of the scrolling is controlled by the speed of the gesture. Additionally, the scroll can be stopped by tapping chart area 1000 (not shown).

FIG. 11a and FIG. 11b illustrate a zooming action associated with circular chart area 1000. Zooming can increase the magnification of the chart area 1000 and in particular the chart trace 1108. Zooming in is achieved by sweeping two fingers together in a pinching motion, while zooming out is preformed by the opposite gesture, moving the two fingers apart. By touch tapping the circular chart area 1000 the display is brought back to its original value (not shown).

Zooming can be preformed along either the time axis or the value axis. FIG. 11a illustrates a zooming gesture along the value axis at several different locations according to hands 1102, 1104, and 1106. FIG. 11b illustrates a zooming action along the time axis at the top of circular chart area 1000 according to hand gesture 1110 and at the bottom of circular chart area 1000 according to hand gesture 1112.

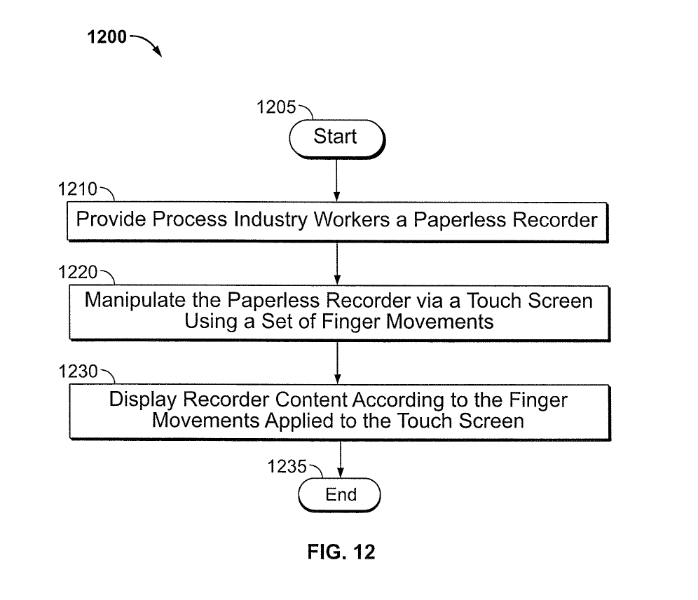

FIG. 12 illustrates a high level flow chart 1200 of logical operational steps associated with a method for navigating a paperless recorder. The method begins at block 1205. Thereafter, a paperless recorder can be outfitted with navigation software, for example software 125, and provided to a user as shown at block 1210. The user can manipulate the paperless recorder, via the touchscreen according to a set of finger movements analogous to those disclosed above, as illustrated by block 1220. Next, at block 1230, the display, such as chart area 204, can be configured to display recorder content according to the finger movements applied to the touchscreen. The method then ends at block 1235.

In summation, the method comprises providing a paperless data recorder. The paperless recorder can provide a strip chart or a circular chart.

The display of the paperless recorder can be manipulated using a variety of finger movements. These movements include motions to manipulate menus and buttons, pan, zoom, and rotate the display, and derive trace values, among others.

The display of the paperless recorder and the associated data on the paperless recorder is then displayed according to the finger movement. Thereby allowing a user to control paperless recorders in a fashion that is intuitively similar to paper-based recorders, which utilizes natural human gestures to accomplish desired actions.

Based on the foregoing, it can be appreciated that a number of embodiments, alternative or preferred, are disclosed. For example, in an embodiment, an interface method can be implemented, which includes the steps of displaying data on a touchscreen of a paperless recorder, manipulating the display of the paperless recorder using a plurality of finger movements, and redisplaying the paperless recorder data on the touchscreen of the paperless recorder according to the plurality of finger movements. In another embodiment, the paperless recorder can provide a strip chart. In still another embodiment, the paperless recorder can provide a circular chart.

In other embodiments, the step of manipulating the display of the paperless recorder, can further comprise a step of two finger tapping the touchscreen and sweeping the fingers across the touchscreen wherein the two finger tapping and sweeping displays current or historic data on the paperless recorder. In another embodiment, the step of manipulating the display of the paperless recorder, can further comprise the step of spreading two fingers away from each other to provide a zoom-in display and bring two fingers together to provide a zoom-out display on the paperless recorder.

In yet another embodiment, the step of manipulating the display of the paperless recorder, can further comprise the step of rotating two fingers on the touchscreen display to provide a rotated display on the touchscreen. In still other embodiments, the step of manipulating the display of the paperless recorder, can further comprise the step of tapping a pre programmed hot button to navigate to the predetermined location associated with the hot button. In other embodiments, the step of manipulating the display of the paperless recorder, can further comprise the step of tapping and then sweeping a finger down the touchscreen to provide a pull down display on the display of the paperless recorder. In another embodiment, the step of manipulating the display of the paperless recorder can further comprise a step of manipulating the display of the paperless recorder provides a preview display on the paperless recorder.

In another embodiment, a paperless recorder interface method can be implemented, which includes, for example, the steps of displaying data on a touchscreen of a paperless recorder, manipulating the display of the paperless recorder using a plurality of finger movements, and redisplaying the paperless recorder data on the touchscreen of the paperless recorder according to the plurality of finger movements.

In another embodiment, the step of manipulating the display of the paperless recorder using a plurality of finger movements, can further comprise the steps of two finger tapping the touchscreen and sweeping the fingers across the touchscreen wherein the two finger tapping and sweeping displays current or historic data on the touchscreen recorder, spreading two fingers apart on the touchscreen in order to zoom-in, bringing two fingers together on the touchscreen in order to zoom-in, rotating two fingers on the touchscreen in order to rotate the display, and tapping and sweeping a finger down the touchscreen to provide a pull down display.

In still another embodiment, a system for software interface with a paperless recorder, can be implemented that includes, for example, a processor, and a data bus coupled to the processor. Additionally, such a system can include a computer-usable medium embodying computer code, the computer-usable medium being coupled to the data bus. In some embodiments, the computer program code can includes instructions executable by the processor and configured for displaying data on a touchscreen of the paperless recorder, manipulating the display of the paperless recorder using a plurality of finger movements, and redisplaying the paperless recorder data on the touchscreen of the paperless recorder according to the plurality of finger movements. In some embodiments, the paperless recorder can provide a strip chart and/or a circular chart.

In other embodiments, the aforementioned instructions can be configured for two finger tapping the touchscreen and sweeping the fingers across the touchscreen wherein the two finger tapping and sweeping displays current or historic data on the paperless recorder, spreading two fingers away from each other to provide a zoom-in display and bring two fingers together to provide a zoom-out display on the paperless recorder, rotating two fingers on the touchscreen display to provide a rotated display on the touchscreen, tapping a pre programmed hot button to navigate to the predetermined location associated with the hot button, tapping and then sweeping a finger down the touchscreen to provide a pull down display on the display of the paperless recorder, and/or manipulating the display of the paperless recorder provides a preview display on the paperless recorder.

While the present invention has been particularly shown and described with reference to a preferred embodiment, it will be understood by those skilled in the art that various changes in form and detail may be made therein without departing from the spirit and scope of the invention. It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A software interface method comprising:
displaying data on a touchscreen of a paperless recorder;
manipulating said display of said paperless recorder using a plurality of finger movements;
redisplaying said paperless recorder data on said touchscreen of said paperless recorder according to said plurality of finger movements.

2. The method of claim 1 wherein said paperless recorder provides a strip chart.

3. The method of claim 1 wherein said paperless recorder provides a circular chart.

4. The method of claim 1 wherein manipulating said display of said paperless recorder further comprises:
two finger tapping said touchscreen and sweeping said fingers across said touchscreen wherein said two finger tapping and sweeping displays current or historic data on said paperless recorder.

5. The method of claim 1 wherein manipulating said display of said paperless recorder further comprises:
spreading two fingers away from each other to provide a zoom-in display and bring two fingers together to provide a zoom-out display on said paperless recorder.

6. The method of claim 3 wherein manipulating said display of said paperless recorder further comprises:
rotating two fingers on said touchscreen display to provide a rotated display on said touchscreen.

7. The method of claim 1 wherein manipulating said display of said paperless recorder further comprises:
tapping a pre programmed hot button to navigate to the predetermined location associated with said hot button.

8. The method of claim 1 wherein manipulating said display of said paperless recorder further comprises:
tapping and then sweeping a finger down said touchscreen to provide a pull down display on said display of said paperless recorder.

9. The method of claim 1 wherein manipulating said display of said paperless recorder further comprises:
The system of claim 10 wherein manipulating said display of said paperless recorder provides a preview display on said paperless recorder.

10. A paperless recorder interface method comprising:
displaying data on a touchscreen of a paperless recorder;
manipulating said display of said paperless recorder using a plurality of finger movements;
redisplaying said paperless recorder data on said touchscreen of said paperless recorder according to said plurality of finger movements.

11. The method of claim 11 wherein manipulating said display of said paperless recorder using a plurality of finger movements further comprises:
two finger tapping said touchscreen and sweeping said fingers across said touchscreen wherein said two finger tapping and sweeping displays current or historic data on said touchscreen recorder;
spreading two fingers apart on said touchscreen in order to zoom-in;
bringing two fingers together on said touchscreen in order to zoom-in;
rotating two fingers on said touchscreen in order to rotate said display; and
tapping and sweeping a finger down said touchscreen to provide a pull down display.

12. A system for software interface with a paperless recorder, comprising:
a processor;
a data bus coupled to said processor; and
a computer-usable medium embodying computer code, said computer-usable medium being coupled to said data bus, said computer program code comprising instructions executable by said processor and configured for:
displaying data on a touchscreen of said paperless recorder;
manipulating said display of said paperless recorder using a plurality of finger movements;
redisplaying said paperless recorder data on said touchscreen of said paperless recorder according to said plurality of finger movements.

13. The system of claim 10 wherein said paperless recorder provides a strip chart.

14. The system of claim 10 wherein said paperless recorder provides a circular chart.

15. The system of claim 10 wherein manipulating said display of said paperless recorder further comprises:
two finger tapping said touchscreen and sweeping said fingers across said touchscreen wherein said two finger tapping and sweeping displays current or historic data on said paperless recorder.

16. The system of claim 10 wherein manipulating said display of said paperless recorder further comprises:
spreading two fingers away from each other to provide a zoom-in display and bring two fingers together to provide a zoom-out display on said paperless recorder.

17. The system of claim 14 wherein manipulating said display of said paperless recorder further comprises:
rotating two fingers on said touchscreen display to provide a rotated display on said touchscreen.

18. The system of claim 10 wherein manipulating said display of said paperless recorder further comprises:
tapping a pre programmed hot button to navigate to the predetermined location associated with said hot button.

19. The system of claim 10 wherein manipulating said display of said paperless recorder further comprises:
tapping and then sweeping a finger down said touchscreen to provide a pull down display on said display of said paperless recorder.

20. The system of claim 10 wherein manipulating said display of said paperless recorder further comprises:
The system of claim 10 wherein manipulating said display of said paperless recorder provides a preview display on said paperless recorder.
